(19) United States
(12) Patent Application Publication
(10) Pub. No.: US 2018/0039762 A1
(43) Pub. Date: Feb. 8, 2018

(54) Systems and Methods For Matching Patients To Best Fit Providers Of Chronic Disease Prevention Programs

(71) Applicant: Solera Health, Inc., Phoenix, AZ (US)

(72) Inventor: Brenda Schmidt, Phoenix, AZ (US)

(21) Appl. No.: 15/783,727

(22) Filed: Oct. 13, 2017

Related U.S. Application Data
(63) Continuation of application No. 15/049,723, filed on Feb. 22, 2016.
Application No. 15/049,723 is a continuation-in-part of application No. 14/808,956, filed on Jul. 24, 2015.

(51) Int. Cl. G06F 19/00

(52) U.S. Cl. CPC G06F 19/363; G06F 19/3437; G06F 19/322; G06F 19/324

(57) ABSTRACT

Systems and methods are provided for matching a candidate for a chronic disease prevention program with a best fit program provider. The method includes determining a respective ideal profile for each of a plurality of program providers; segmenting a heterogeneous patient population into a plurality of homogeneous sub-groups; collecting patient data for the candidate; assigning the candidate to a first one of the homogeneous sub-groups based on the patient data; comparing the first sub-group to a plurality of the respective ideal profiles; and determining a best fit program provider based on comparing the first sub-group to a plurality of the respective ideal profiles.

### RELATED APPLICATION

This is a continuation-in-part (CIP) of U.S. application Ser. No. 14/808,956 filed Jul. 24, 2015, the entire contents of which are hereby incorporated herein.

This patent application is a continuation of U.S. patent application Ser. No. 15/049,723 filed Feb. 22, 2016 and published on Jan. 26, 2017, as US Patent Publication No. 2017/0024546, which is incorporated by reference herein.

### TECHNICAL FIELD

The present invention relates, generally, to systems and methods for selecting optimal chronic disease prevention program providers based on individual patient preferences and, more particularly, to segmenting heterogeneous patient populations into homogeneous sub-groups and applying predictive analytics to determine best fit programs for a patient.

### BACKGROUND

The evolving U.S. health care system presents opportunities for improving population health. As described in the January, 2014 article entitled “Twin Pillars of Transformation: Delivery System Redesign and Paying for Prevention”, available at www.healthyamericans.org, population health offers better care for patients, better health for the population, and lower healthcare costs by reversing the escalating epidemic of chronic diseases such as obesity, diabetes, and cardiovascular disease. A key component of population health involves linking clinical care with community-based prevention programs and related social services. The Journal for Public Health Management and Practice, “Population-Based Health Principles in Medical and Public Health Practice” (http://journals.lww.com/jphmp/Abstract/2001/07030/Populalion Based Health Principles in Medical and.12.aspx), notes that traditional medical education, research, and practice have focused on the care of the individual. Shifting the emphasis to embracing population-based health principles can have a greater effect on long term health and wellness, particularly in the prevention of chronic disease.

Reversing the epidemic of chronic disease requires increased access to evidence-based prevention programs such as the National Diabetes Prevention Program (National DPP). The National DPP is a year-long community-based program delivered in group-based settings as well as virtually (on line) and supported by a trained lifestyle coach. The program helps patients modify their eating and physical activity habits and sustain lifestyle changes, coupled with a modest (e.g., 5%-7%) weight loss goal. The National DPP has been shown to reduce the risk of developing T2DM by 58% for prediabetic adults over 25 years of age, and by 71% for adults over 60.

More than 700 community-based organizations (CBOs) and digital/virtual program providers have been granted pending or full recognition status as National DPP providers by the Centers for Disease Control and Prevention (CDC) (http://www.cdc.gov/diabetes/prevention/recognition). However, disparate community-based and virtual DPP providers are not supported through a coordinated approach to patient identification, referrals, program delivery, and payment. At present, healthcare providers supply their eligible patients with a list of organizations offering the National DPP, relying on the patient to follow up directly with a provider organization. Unfortunately, this type of “opt-in” approach tends to result in significantly lower enrollment, in part because prevention programs offered by community-based organizations are typically not covered by most health insurance plans. More recently, insurers have begun to adopt the National DPP as a covered benefit for their members. However, most National DPP providers lack the infrastructure to submit medical claims for their services, and it would be cumbersome and costly for health plans to independently contract with each community-based or virtual National DPP provider.

It is also known that patient behavior is a key metric in the success of chronic disease prevention programs. Consequently, chronic disease prevention programs should deliver against patients' needs, preferences and expectations. “One size fits all” programs and delivery methods have limited success because all patients are not alike—even when they share a common health condition. See, for example, the discussion of demographic segmentation, psychographic segmentation, and behavioral segmentation at http://www.examstutor.com/business/resources/studyroom/marketing/market_analysis/7_demographic_segmentation.php et seq.; and the Commonwealth Fund “Quality Matters” at http://www.commonwealthfund.org/publications/newsletters/quality-matters/2015/june. The entire contents of the forgoing articles are incorporated herein by this reference. Presently known prevention program delivery models lack sufficient understanding of consumer preferences and how to effectively influence their choices.

Systems and methods are thus needed which overcome these limitations. Various desirable features and characteristics will also become apparent from the subsequent detailed description and the appended claims, taken in conjunction with the accompanying drawings and this background section.

### BRIEF SUMMARY

Various embodiments of the present invention relate to systems and methods for: i) determining an “ideal” participant profile for each of a plurality of programs and/or program providers based on the quality of participant engagement and successful outcomes; ii) segmenting heterogeneous patient populations into homogeneous sub-groups to identify participants who match the ideal profile; and iii) enrolling the identified participant in the best fit program. Accommodating individual patient needs and preferences in this way enables a more personalized approach to care, allowing health plans to engage with their members through prevention, thereby mitigating the higher long term costs of chronic disease treatment.

Presently known machine learning technologies include Watson™ available from IBM and Azure™ available from Microsoft. It is possible to use current technologies to identify likely candidates for program intervention from within a patient population based on, for example, each patient's likelihood of incurring health care costs, presence and acuity of chronic health conditions, biometric data, and readiness to change. Intervention strategies undertaken by health plans, whether nurse practitioners in a care management call center, pharmacists coaching individuals on the use of medications, formulary management of primary and specialty care drugs or alternative benefits plans, are each appropriate for only certain individuals within the population.

The present invention, on the other hand, uses predictive analytics and machine learning to pair a particular candidate with a specific one of several programs having analogous content, based on a prediction that the candidate will do well in the optimally selected program. Health plans have historically lacked the capabilities to precisely select the individuals appropriate for varied intervention methodologies, using a one-size fits all approach.

Stated another way, prior art approaches identify which patients should be treated by a particular intervention; whereas the present invention identifies best fit programs from a wide variety of treatment providers for patients already identified as candidates for treatment.

In an embodiment, segmentation involves analytic techniques to break down a heterogeneous population into smaller, homogeneous groups composed of individuals with similar needs, preferences, attitudes and behaviors. These segments are then analyzed with variables from a broader behavioral database (e.g., medical claims data). Unique, segment-specific variables may be isolated and extrapolated across a database population to flag each patient according to his or her segment. The emergent segments may then be profiled against the “ideal” patient profile based on engagement and outcome data from each program provider.

A series of algorithms and/or branched logic may be used to determine one or more “best match” programs for each participant, allowing the participant to explore options based on his or her expressed preferences. Successful application of these insights can positively drive program engagement and influence health and wellness behaviors, and support ongoing retention and successful program completion.

In an embodiment, a diverse network of program providers each deliver similar evidence-based programs having variations in how the program is delivered, which may be used to quantify participant preferences (which may be programmatically weighted). Using predictive analytics, the system determines the profile of the “ideal participant” for each program provider based on the foregoing variables and individual participant characteristics. This profile represents a hypothetical participant most likely to be successful in each program based on delivery methodology.

After matching participant-specific data to various ideal participant profiles, the system programmatically (e.g., algorithmically) selects the program provider best suited to the participant. In this context, the participant-specific data may include, inter alia, patient contact information (including zip code), demographics, socio-economic factors, psychographics, health information, health care utilization, claims data, electronic medical record data, prescription history, and purchasing data (collectively referred to herein as the “Patient Data”).

It should be noted that the present invention, while described in the context of Diabetes Prevention, it is not so limited. Those skilled in the art will appreciate that the systems and methods described herein may contemplate any prevention or treatment program, as well as chronic disease management, telemedicine, medication and dosage adherence, social services, behavioral health, and the like.

Various other embodiments, aspects and features are described in greater detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a schematic block diagram of an exemplary system for facilitating the provision of disease prevention programs in accordance with various embodiments;

FIG. 2 is a schematic block diagram of an integrator including an integrator computer module having a processor, a database of program providers, and a database of participants received from a plurality of sources in accordance with various embodiments;

FIG. 3 is a block diagram of a provider, a plan administrator, a CBO or virtual provider, and an integrator in accordance with various embodiments;

FIG. 4 is a process flow diagram illustrating an exemplary use case involving the provider, plan administrator, CBO, and an integrator of FIG. 3 in accordance with various embodiments;

FIG. 5 is a flow chart illustrating a process for maintaining compliance with a minimum biometric population in accordance with various embodiments;

FIG. 6 is an exemplary screen shot illustrating summary enrollment data for a list of program sponsors in accordance with various embodiments;

FIG. 7 is a screen shot illustrating detailed information for a particular program sponsor in accordance with various embodiments;

FIG. 8 is a screen shot illustrating detailed information for an individual participant in accordance with various embodiments;

FIGS. 9-11 are screen shots illustrating detailed information for a particular disease prevention program (class schedule) in accordance with various embodiments;

FIG. 12 is a screen shot illustrating detailed information for the participants enrolled in a particular class in accordance with various embodiments;

FIG. 13 is a screen shot illustrating detailed information for a list of classes and corresponding program sponsors in accordance with various embodiments; and

FIG. 14 is a screen shot illustrating detailed information for a plurality of participants including identifying information, biometric information, status information, personal information and other notes in accordance with various embodiments;

FIG. 15 is an exemplary spread sheet of providers within a managed provider network in accordance with various embodiments;

FIG. 16 is a chart useful in ranking providers along three axes: i) a level of assistance spectrum from “do it myself” (minimal assistance) to “do it for me” (maximum assistance); ii) participant body mass index (BMI); and iii) desired percentage weight reduction in accordance with various embodiments;

FIG. 17 is a schematic block diagram illustrating the creation of ideal participant profiles for a plurality of program providers in accordance with various embodiments;

FIG. 18 is a flow diagram illustrating the creation of ideal participant profiles for a plurality of program providers in accordance with various embodiments;

FIG. 19 is a flow diagram illustrating a process by which a heterogeneous population is segmented into smaller homogeneous sub-groups characterized by segment-specific variables in accordance with various embodiments; and

FIG. 20 is a flow diagram illustrating a process by which a best fit program provider is determined for a candidate participant is in accordance with various embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to systems and methods for linking primary care providers with CBOs or virtual providers to provide disease prevention and other programs. The present invention further contemplates systems and methods for segmenting heterogeneous patient populations into discrete groups to facilitate determining a best fit program for a particular participant candidate. In this context, “best fit” implies deep engagement to ensure satisfaction of milestones, as well as successful program completion. These programs include, inter alia, the following categories: i) lifestyle/prevention (pre-chronic); ii) chronic disease (e.g., congestive heart failure, arthritis, cavity prevention, falls prevention, diabetes, back pain, COPD, hypertension, cardiovascular disease); iii) behavioral health (e.g., addiction, domestic violence, anger management, depression, anxiety); and iv) pharmaceuticals, including compliance and dosage protocols.

In various embodiments, an integrator (described in detail below) manages a network of community and digital providers vetted, validated, and approved by the Center for Disease Control (CDC) to deliver diabetes and other chronic disease prevention programs. The integrator also processes candidates eligible for one or more programs, which are typically paid for by a health plan as a “covered” preventative benefit under the Affordable Care Act (ACA). In this context, a covered benefit typically implies that there is no co-pay and no deductible associated with the benefit. Significantly, in accordance with various embodiments, it is the integrator—not the program provider—which has a contractual relationship with the health plan health system or healthcare provider (collectively “payer”) to secure payment from the payer to the program provider. Consequently, a consumer (also referred to herein as a patient, participant, or candidate) is encouraged to seek a referral from the integrator to a program provider, as opposed to directly engaging a program provider.

In an embodiment, a payer typically reimburses a program provider based on a pay-for-performance model using predetermined milestones for engagement and outcomes. Consequently, the program provider is incented to encourage the consumer to finish the program so that the provider gets paid. The program provider further benefits from successful completion inasmuch as the integrator provides aggregate program completion data to the CDC and these data support ongoing recognition of the provider by the CDC, thereby allowing the provider to continue offering the program. It is also in the payers' interest that the patient successfully completes the program because it is generally cheaper to prevent chronic disease, than to provide long-term treatment following full disease onset.

An early step in the process of matching a participant to a best fit program involves determining whether the participant is eligible for one or more programs based on objective criteria as defined by the health plan or payer. For example, qualifying criteria for a diabetes prevention program may include: i) age over 18 and body mass index (BMI) over 24; and ii) age over 65 or a combination of being overweight and getting little exercise. In an embodiment, once eligibility is confirmed, the system may present a drop down menu which allows the participant to select his/her health plan. If not covered by a health plan, the participant may elect to self-pay. The system then starts collecting information (demographic, psychographic, medical, etc.) using branched logic. In one embodiment, a participant can override the interactive data collection process and directly select a particular program, if desired.

In accordance with various embodiments, the system programmatically (e.g., algorithmically) determines an ideal patient profile for the most successful participants for each provider. For example, the system identifies a first set of metrics common to the top graduates of a particular provider such as, for example, Jenny Craig™. The system also identifies a second set of metrics common to the top graduates of Weight Watchers™, and so on. After gathering Patient Data (defined below) for a particular candidate, the system employs machine learning and predictive analytics tool to recommend one or more “best fit” programs based on correlations between the candidate's Patient Data and a plurality of ideal profiles.

In various embodiments, segmentation employs analytic techniques to break down a heterogeneous population down into smaller, homogeneous groups composed of individuals with similar needs, preferences, attitudes and behaviors. These segments are then analyzed with variables from a broader behavioral database (e.g., medical claims data). Unique, segment-specific variables may be isolated and extrapolated across a database population to flag each patient according to his or her segment. The emergent segments are then profiled against the “ideal” patient based on engagement and outcome data from each program provider.

A series of algorithms and/or branched logic may be used to determine one or more “best fit” programs for a candidate, thereby allowing the candidate to explore options based on his or her expressed preferences. Successful application of these insights can positively drive program engagement and influence health and wellness behaviors, and support ongoing retention and successful program completion.

The following table summarizes suitable exemplary segmentation criteria, some or all of which may be useful in the aforementioned segmentation process as well as defining Patient Data for an individual candidate:

| Criteria | Example |
|---|---|
| Demographic | Age, gender, ethnicity, race, |
| and | education, income, and other physical |
| Socioeconomic | and situational characteristics. |
| | Zip code links to zip code specific |
| | social determinants of health and |
| | directory of local social services for |
| | cross-referrals. |
| Personal/ | Current co-morbid chronic health |
| Family Health | conditions, pregnancy status (if |
| Information | female), limitations to physical |
| and History | activity, Body Mass Index (height + |
| | weight), family history of disease |
| | (i.e. diabetes). |
| Behavioral/ | Current physical activity habits, |
| Attitudinal/ | current stress level, nutrition |
| Readiness | habits, tobacco use status. Readiness |
| | to change based on Prochaska's |
| | Transtheoretical Model. |
| Psychographic | Dimensions that identify motivations |
| Profile | and unarticulated needs. Attitudinal |
| | and behavioral variables based on |
| | the program/service/intervention. |
| | Includes values, beliefs, interests, |
| | principles, emotions, and personality. |
| | Includes needs and preferences for |
| | program services (flexibility, etc.). |
| Dieting | Number or dieting attempts, weight |
| History | loss goal, types of successful/ |
| | unsuccessful attempts. |
| Prescription | To determine, for example, use of |
| Use, History | Metformin for prediabetes or |
| and Compliance | prescription medication that may |
| | impact balance and increase likelihood |
| | of falls. |
| Health Care | For example, emergency room and |
| Utilization | hospitalizations or frequency of |
| and Behaviors | health care utilization and compliance |
| | with preventive exams. |
| Electronic | To determine program/service |
| Medical | intervention qualification. |
| Records or | |
| Claims Data | |

The present system thus selects an optimum program and/or provider (i.e., in which the candidate is most likely to successfully complete) from among many with essentially the same content, based on matching a candidate's success metrics with ideal patient profiles associated with various program providers.

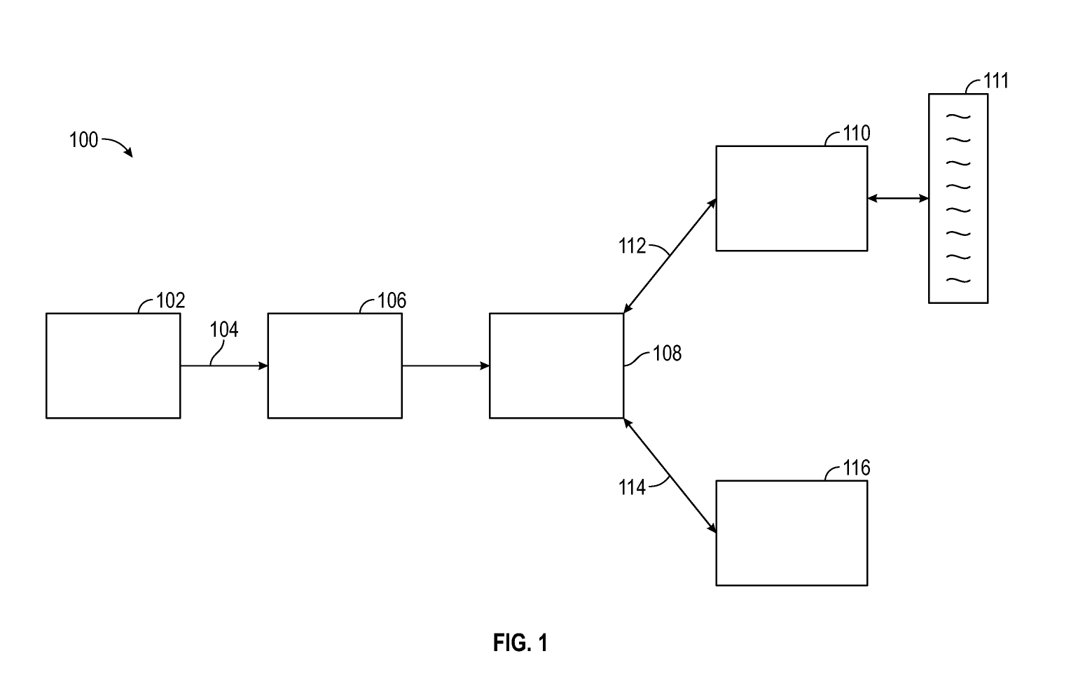

More particularly and referring now to FIG. 1, a system 100 for delivering disease prevention programs (DPPs) includes a clinical provider 102 (doctor, hospital) referring 104 a patient 106 to an integrator 108. The integrator 108 accesses a database 111 of providers and recommends a best fit program 110 based on, inter alia, a correlation between the Patient Data associated with the patient 106 and ideal patient profiles associated with the various providers. As described in greater detail below, the integrator 108 monitors 112 the participant's compliance with the program, and processes a claim for payment 114 from a health plan administrator (also referred to herein as the Plan or Payer) 116.

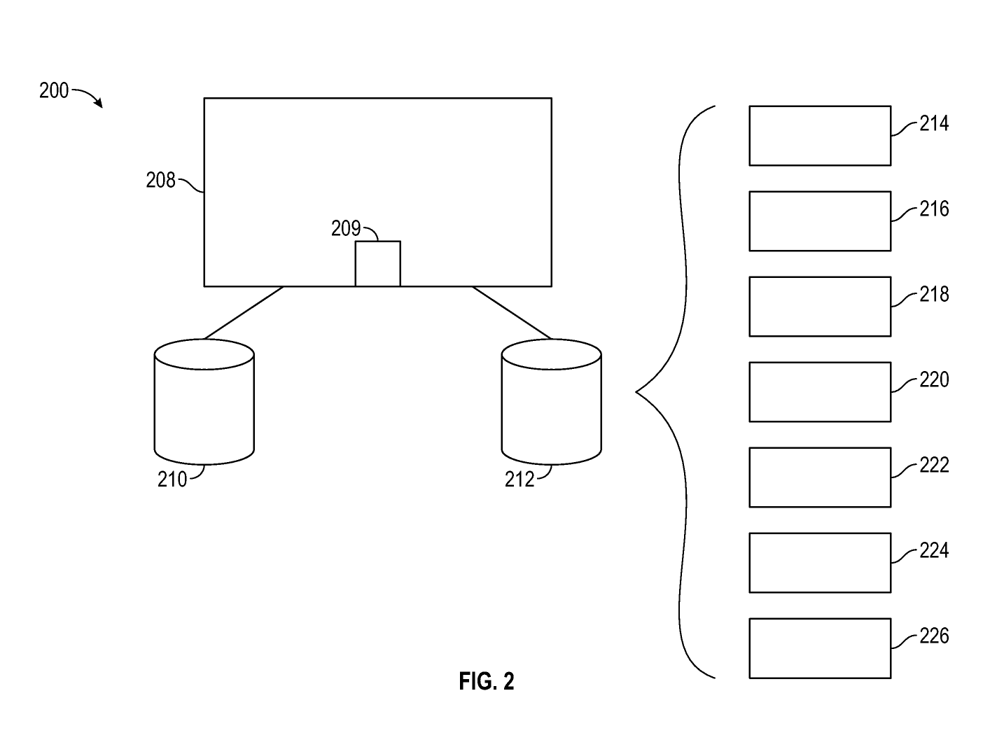

Referring now to FIG. 2, the integrator may be configured to perform any number of the various functions and tasks described herein. For example, a database system 200 illustrates an integrator computer module 208, including a processor or processing system 209, the integrator computer module 208 being configured to maintain a first database 210 of CBOs (some of which may also be clinical providers), and a second database 212 of participants; that is, the integrator builds and manages a vast relational database of health plan members. The integrator computer module 208 may be configured to recruit participants into the database 212 using at least the following sources (also referred to as entry vectors): employers 214, medical providers 216, health systems 218, health plans 220, self-referral 222, network providers 224, and CBOs 226.

The foregoing sources may submit aggregate patient data to the integrator, whereupon the integrator analyses the data to determine eligibility and make program recommendations for qualifying participants.

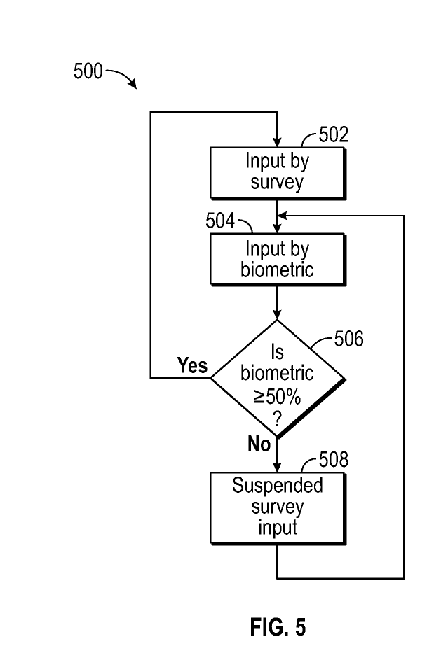

More particularly and with momentary reference to FIG. 5, a process 50o for maintaining real time, steady state compliance with a minimum (e.g., 50%) biometric population within the participant data base includes inputting new participants (Task 502) using surveys, questionnaires, interviews, email requests, or other non-biometric modalities. New participants may also be introduced into the system (Task 504) using biometric modalities such as blood test, glucometer readings, or other laboratory results. The system polls the participant database to determine whether the percentage of biometric-based participants satisfies a predetermined threshold (Task 506). If so (“Yes” branch from Task 506), the system permits new participant input by either modality (biometric and non-biometric). If, on the other hand, the percentage of biometric-based participants does not satisfy the threshold (“No” branch from Task 506), the system may temporarily suspend inputting new participants using surveys or other non-biometric techniques (Task 508), and continue adding new participants using only biometric techniques (Task 504) until the threshold is again satisfied.

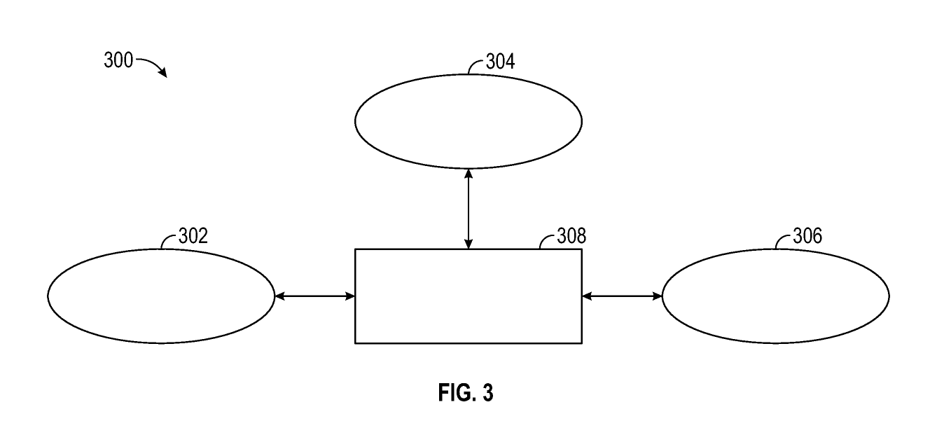

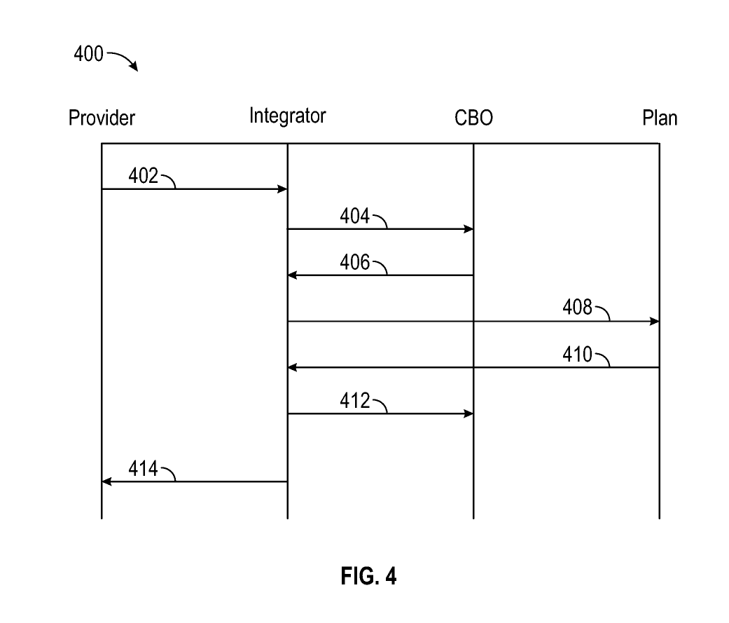

FIG. 3 is a block diagram 300 and FIG. 4 is a process flow diagram 400 illustrating an exemplary use case involving a doctor or hospital 302, a plan administrator 304, a CBO (e.g., a DPP provider) 306, and an integrator 308. More particularly, a hospital refers a participant to an integrator (step 402), whereupon the integrator identifies an appropriate CBO and facilitates enrolling the participant in a prevention program offered by the CBO (step 404). If the participant is already affiliated with a particular health plan, the integrator may permit the health plan to designate a preferred provider (e.g., Weight Watchers™) for one or more prevention programs. Alternatively, the integrator can define a network of CBOs and digital/virtual providers. As the participant progresses through the program, the CBO updates the participant's record within a shared database maintained by the integrator (step 406).

In an embodiment, the integrator may provide an interactive software tool for use by the CBOs to facilitate the integration process, for example, by allowing CBOs to enter participant data (e.g., attendance, body weight, and the like) directly into participant records maintained by the integrator. In an embodiment, such an interactive software tool may include the Solera™ technology platform program available from Solera™ Health, Inc. located in Phoenix, Ariz.

Upon completion of the prevention program or, alternatively, at predetermined milestones (described in greater detail below), the integrator submits a claim or invoice for payment to the payer (step 408). The payer makes payment on the claim to the integrator (step 410), whereupon the integrator makes partial or full payment to the CBO or virtual provider (step 412), reserving for itself (the integrator) compensation for facilitating and managing the process. The integrator may then report back to the provider confirming successful completion of the program by the participant or, alternatively, otherwise reporting the status if the prevention or other program was not successfully completed (step 414). In this way the provider can report aggregate quality metrics regarding the provider's performance to the plan and to Medicare/Medicaid agencies and the CDC.

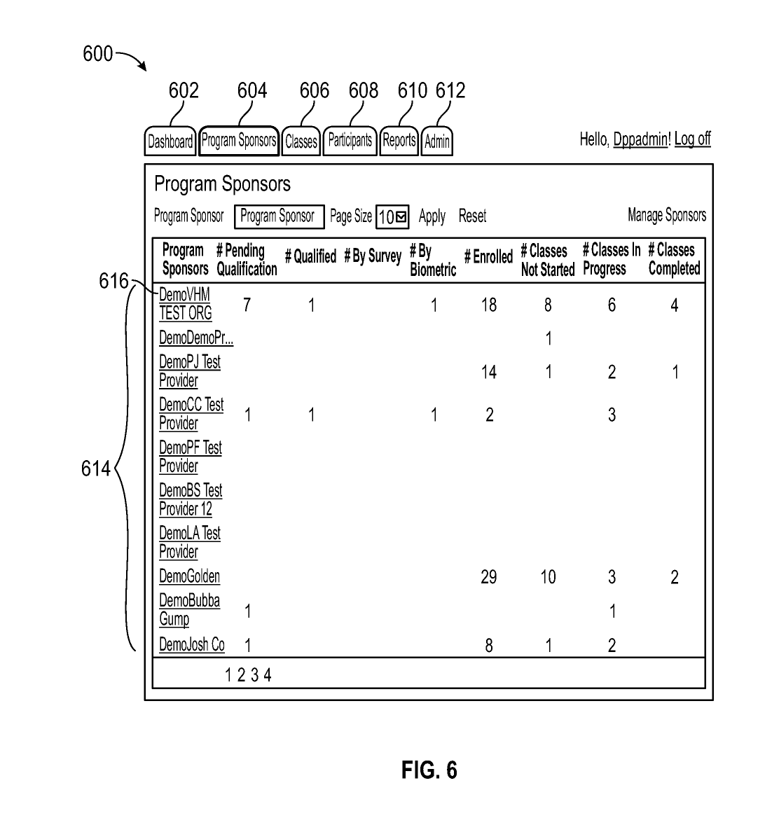

Referring now to FIGS. 6-14, various aspects of an exemplary user interface for implementing the present invention will now be described. With particular reference to FIG. 6, a screen shot 600 includes a Dashboard tab 602, a Program Sponsors tab 604, a Classes tab 606, a Participants tab 608, a Reports tab 610, and an Admin tab 612. In particular, the dashboard tab 602 may be used to access graphical summaries of selected data sets.

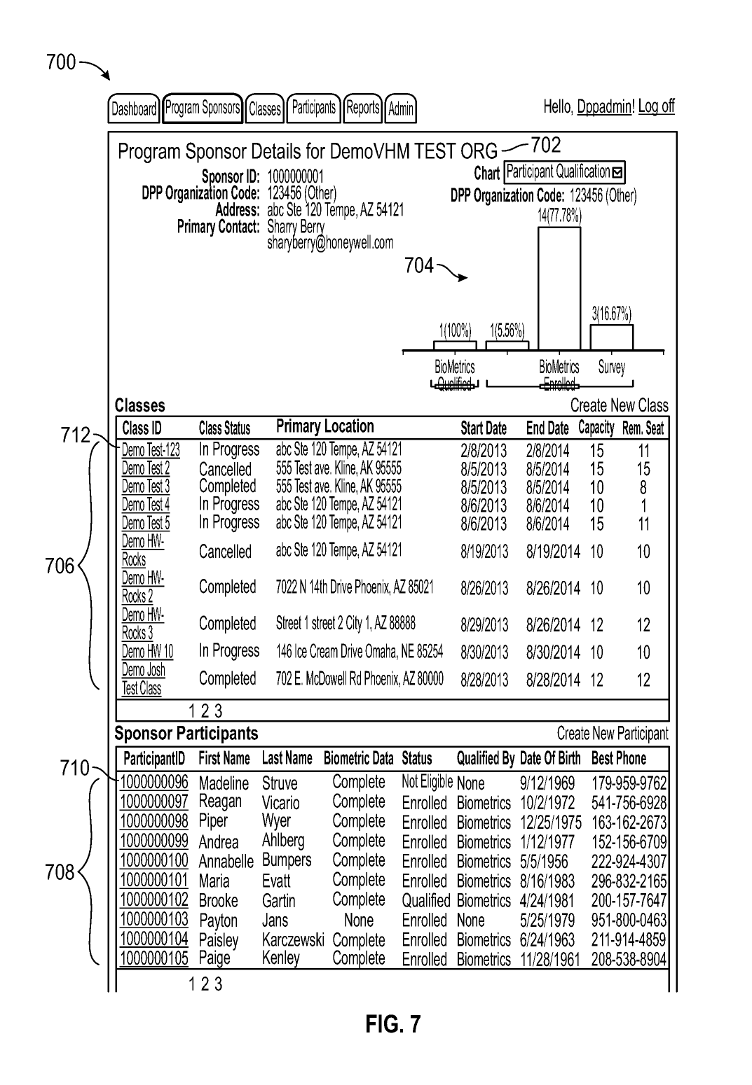

FIG. 7 is a screen shot 700 illustrating detailed information for a particular program sponsor 702 (corresponding to program sponsor 616 of FIG. 6). More particularly, screen shot 700 illustrates a visual summary 704 indicating the number of enrolled and qualified participants, and the relative percentages of enrolled participants who entered the system via biometrics and surveys, respectively. In addition, a list of classes 706 includes, for each class, the class status (e.g., in progress, cancelled, completed, scheduled but not yet started), the location (e.g., street address), the start and end dates, the total capacity, and number of available seats still available (Rem. Seats). In this way, the integrator can efficiently and effectively link participants to classes by comparing the participant's location and schedule to the location and schedules of available classes (prevention programs).

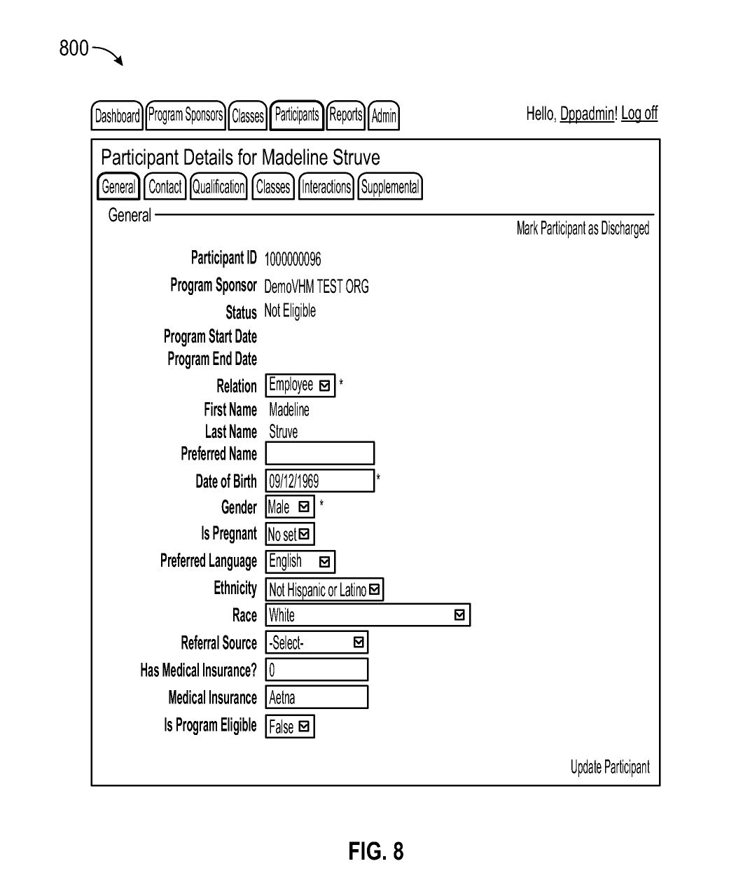

The screen shot 700 further includes a list 708 of participants associated with the program sponsor's classes. The list 708 suitably includes, for each participant, the participant's status (e.g., enrolled, qualified, not eligible), the status pf the participant's biometric data (e.g., completed), and various personal information such as birth date and contact information (e.g., email address and telephone number). Clicking on a particular individual participant 710 reveals detailed information for that individual, as illustrates in the screen shot 800 of FIG. 8.

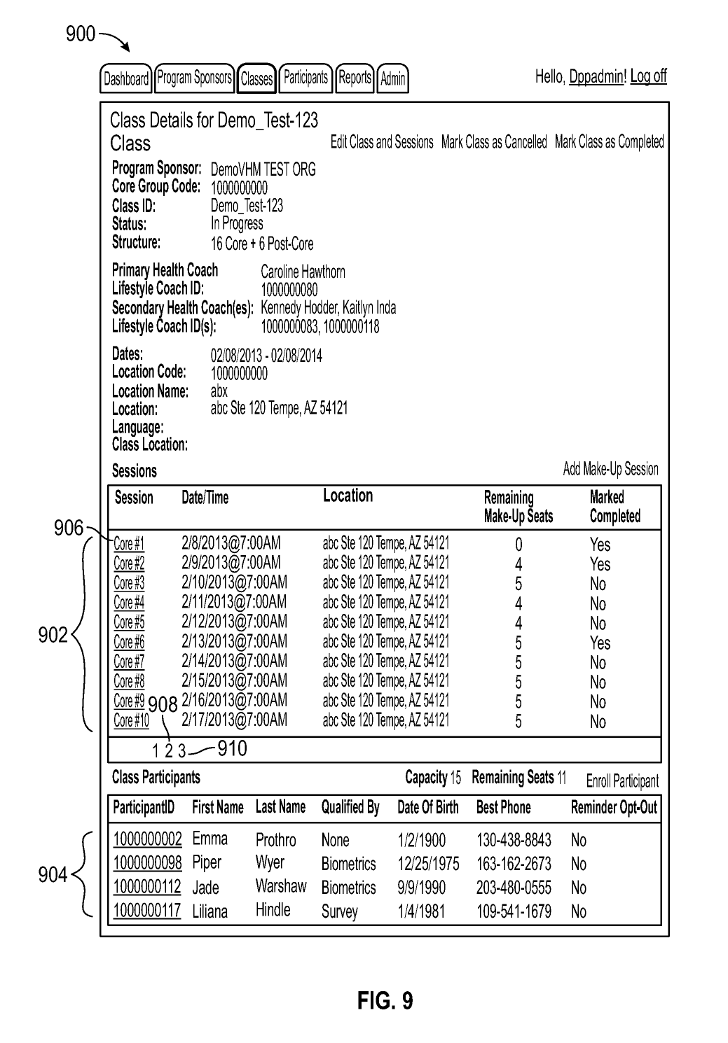

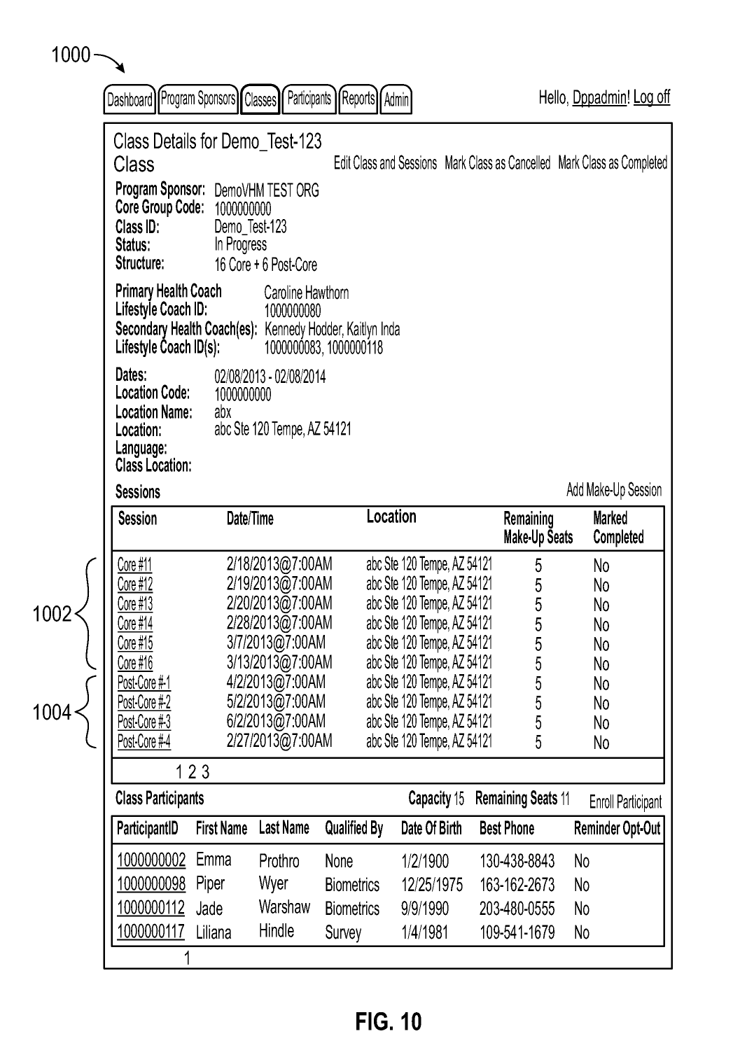

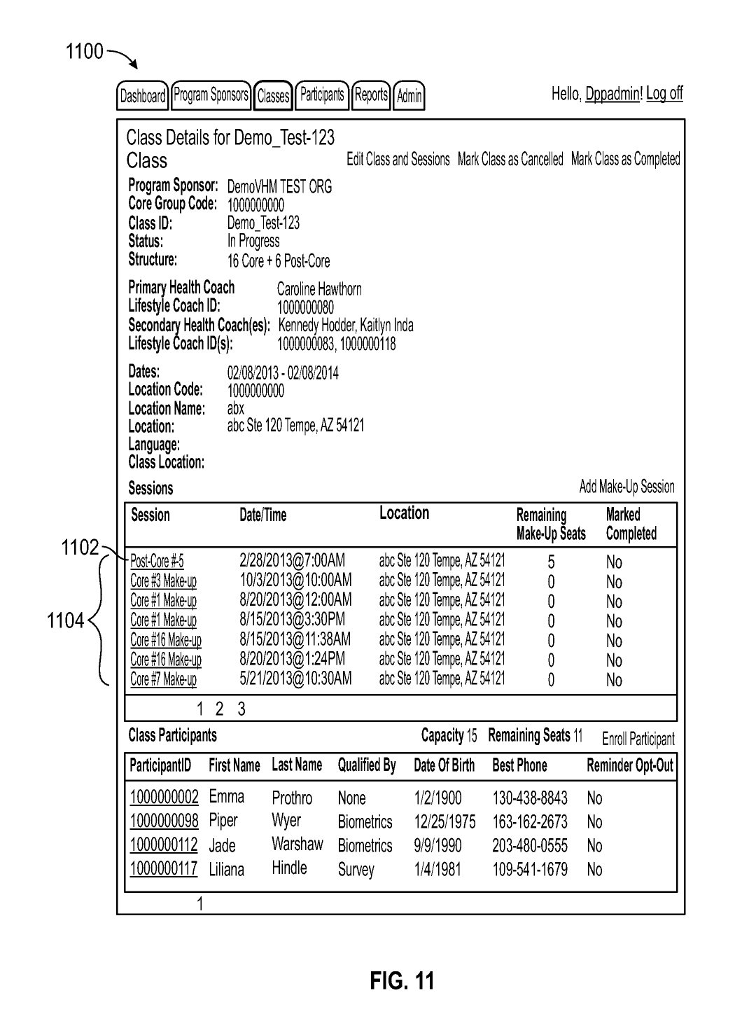

With momentary reference to FIG. 7 and referring now to FIG. 9, clicking on a particular prevention program 712 (FIG. 7) reveals detailed information for that class, as shown in screen shot 900. More particularly, screen shot 900 includes a first portion 902 of a class schedule for a particular prevention program. A second portion of the class schedule may be revealed by selecting a second page icon 908 (corresponding to FIG. 10), and a third portion of the class schedule may be revealed by selecting a third page icon 910 (corresponding to FIG. 11). The screen shot 900 also includes a list 904 of participants enrolled in the selected class.

FIG. 10 is a screen shot 1000 depicting six additional core segments 1002 and four post core segments 1004. FIG. 11 is a screen shot 1100 depicting an additional post core segment 1102 and any number of make-up segments 1104. In an embodiment, the program includes sixteen weekly classes (core #1-16), followed by five monthly classes (post core #1-5). Alternatively, the program may consist of any desired combination of classes scheduled at any desired intervals (daily, weekly, bi-weekly, monthly, and the like).

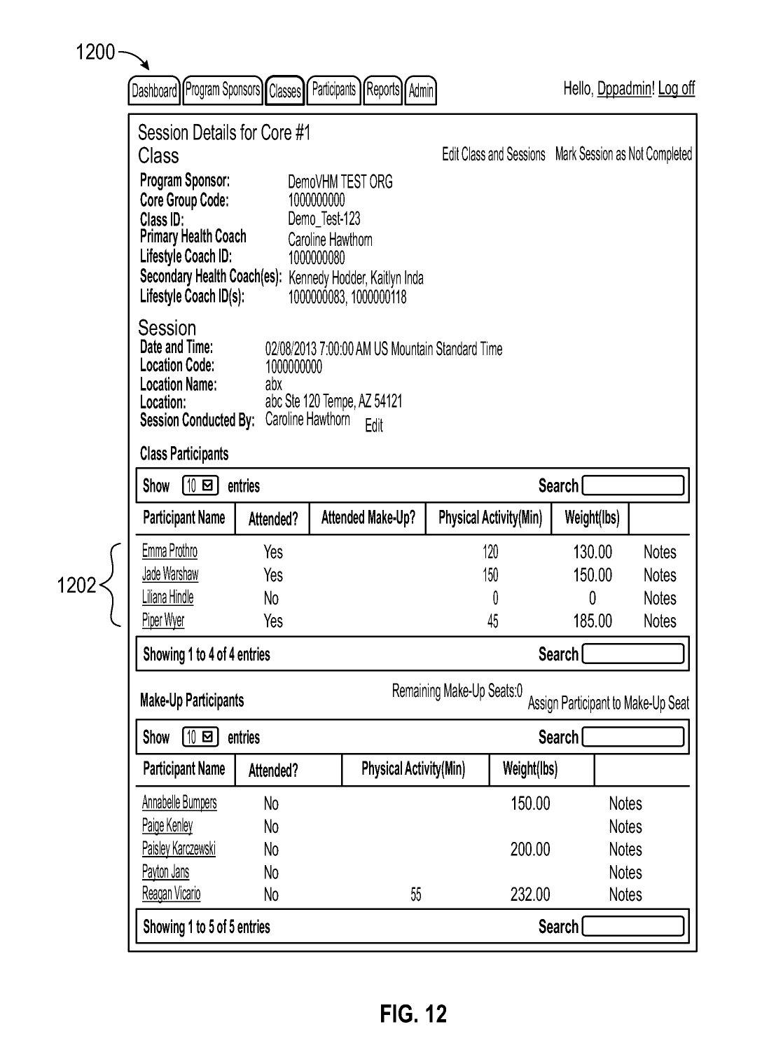

Referring again to FIG. 9, clicking on a particular class 906 reveals details of that class' participants, for example, as shown in a screen shot 1200 of FIG. 12. In particular, the screen shot 1200 includes, for each of a plurality of participants 1202, in indication of whether the participant in fact attended the class and, if so, the participant's weight, level of physical activity (e.g., expressed in minutes), and any other relevant parameters or metrics. In an embodiment, a class instructor (coach) may access the interactive software tool shown in FIG. 6 et seq. to enter information into the various fields. Alternatively, the tool may be configured to permit participants to enter biometric and other information, as appropriate.

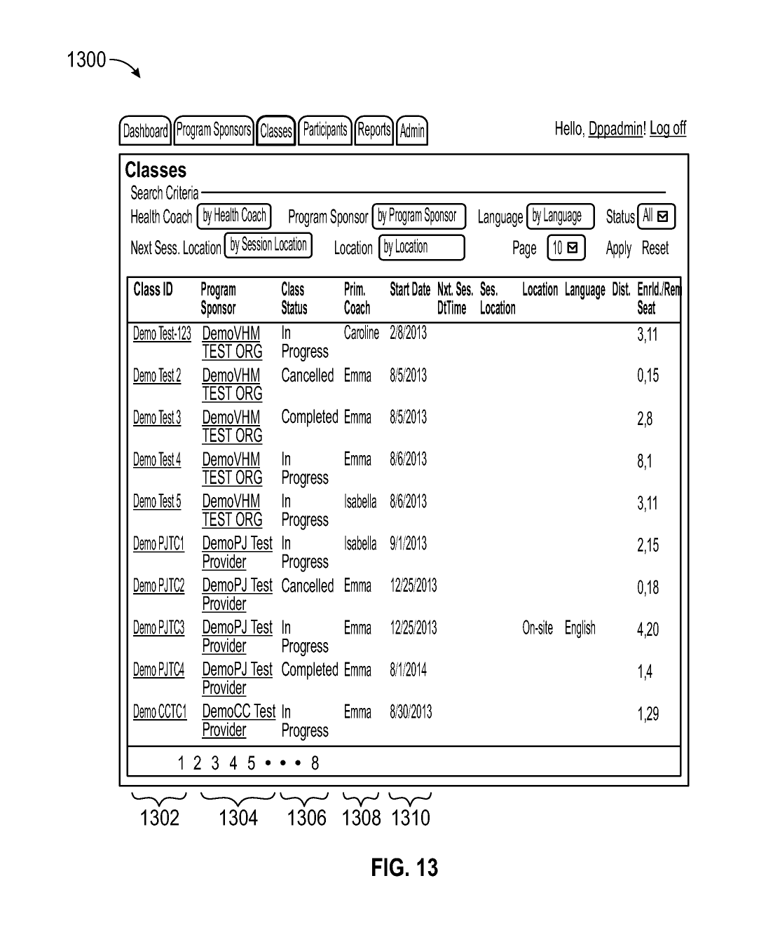

FIG. 13 is a screen shot 1300 depicting details associated with the classes tab 606 of FIG. 6. More particularly, the screen shot 1300 includes a list of classes 1302, corresponding program sponsors 1304 and, for each class, a status field 1306 (e.g., in progress, canceled), a start date 1310, and the instructor or primary coach 1308.

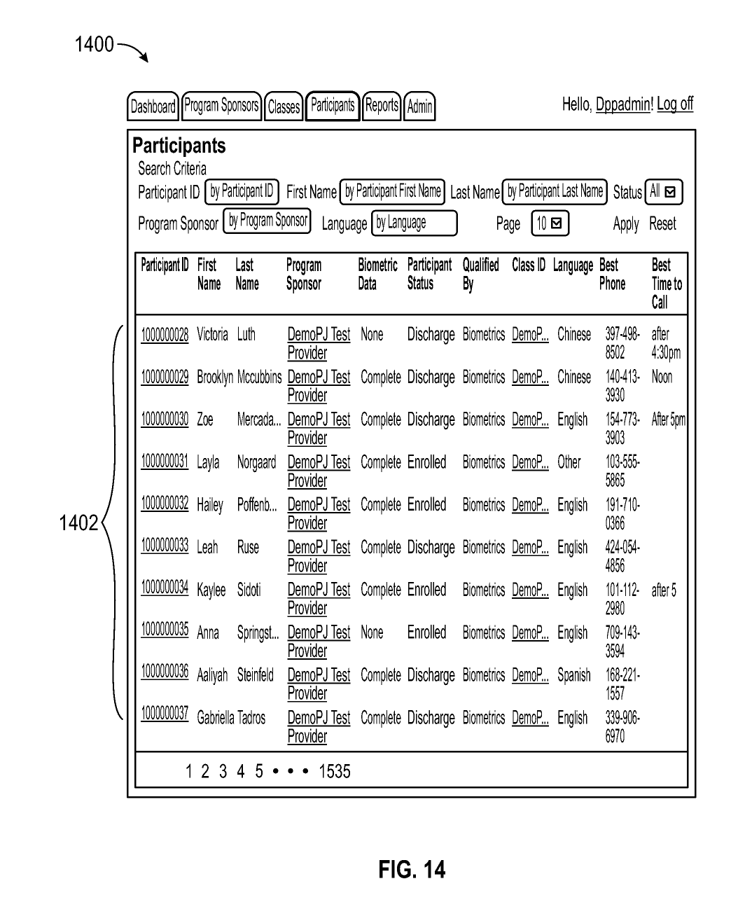

FIG. 14 is a screen shot 1400 depicting details associated with the participants tab 608 of FIG. 6. More particularly, the screen shot 1400 includes, for each of a plurality of participants 1402, identifying information, biometric information, status information, personal information (e.g., preferred language) and any other notes which may have been entered into the system entered by a coach or administrator.

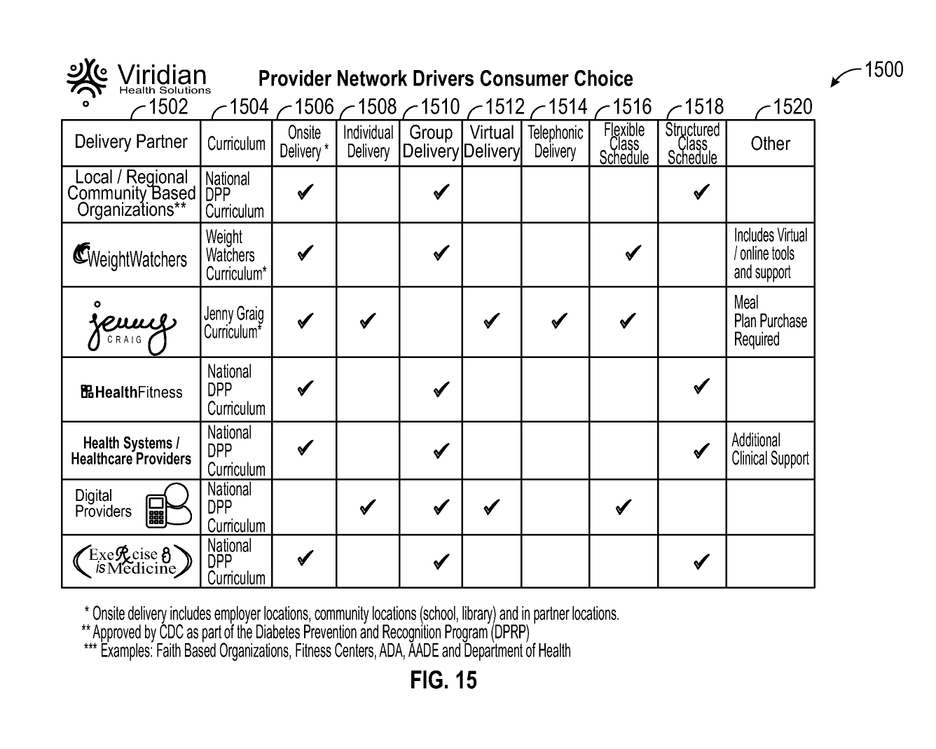

Referring now to FIGS. 15-21, various embodiments for determining a best fit program provider for a patient candidate will now be described in greater detail.

FIG. 15 is an exemplary spread sheet 1500 of program providers (Delivery Partners) 1502 within a managed provider network in accordance with various embodiments. More particularly, the spreadsheet 1500 includes a number of columns identifies various delivery metrics associated with each program provider, including: type of curriculum 1504; onsite delivery 1506; individual delivery 1508; group delivery 1510; virtual delivery 1512; telephonic delivery 1514; flexible class schedule 1516; structured class schedule 1518; and other features 1520 such as online tools/support, meal plans, and clinical support.

In conjunction with the foregoing, the following delivery metrics together comprise needs and preference variables (NPVs) useful in the context of the present invention: Online, mobile, text, telephonic, video-chat or in-person intervention; i) one-on-one individual interventions or group-based program delivery; ii) group participation is optional or required; iii) groups are defined (the same people interact on a regular basis) and consistent, or groups are not defined (group membership varies from class to class); iv) content delivery and program participation is self-paced or follows a specific schedule; v) group participation is synchronous (e.g., weekly required webinar) or asynchronous (e.g., group interaction happens via chat or mobile discussion boards); vi) the intervention is led by a lay health educator or a clinician; vii) a member of the patient's clinical care team is incorporated into the program delivery vs the clinical care team receiving regular reporting from the program provider; viii) daily meal logging, taking pictures of food, volumetrics, or point systems; ix) frequency of health coach interaction (e.g., multiple times per day, daily, as needed, or weekly); x) patient's need for flexibility in day, time or location; xi) the method by which a standardized curriculum is delivered to the patient (e.g., video, quiz, printed materials); and xii) monitoring of weight, physical activity, medication and testing compliance or other biometrics via wearables and remote patient monitoring devices.

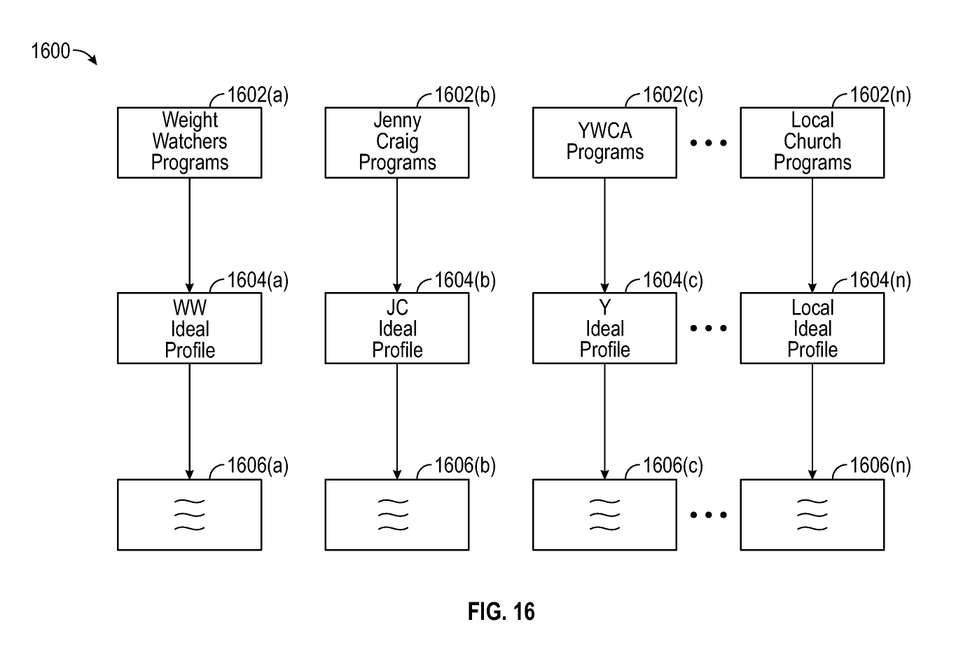

Referring now to FIG. 16, a schematic block diagram 1600 illustrates a plurality of program providers 1602(a)-1602(n), each having an ideal profile 1604(a)-1604(n) associated therewith. In an embodiment, each ideal profile 1604(a)-1604(n) represents the common characteristics of participants who successfully completed that provider's program, and may comprise a unique set of NPVs 1606(a)-1606(n). For example, a first set of NPVs 1606(a) corresponding to provider 1602(a) may include in person, group based regular meetings having a specific schedule and led by a clinician; a second set of NPVs 1606(b) corresponding to provider 1602(b) may include an on-line, mobile, self-paced program with daily meal logging and which uses a wearable device to monitor biometrics, and so on.

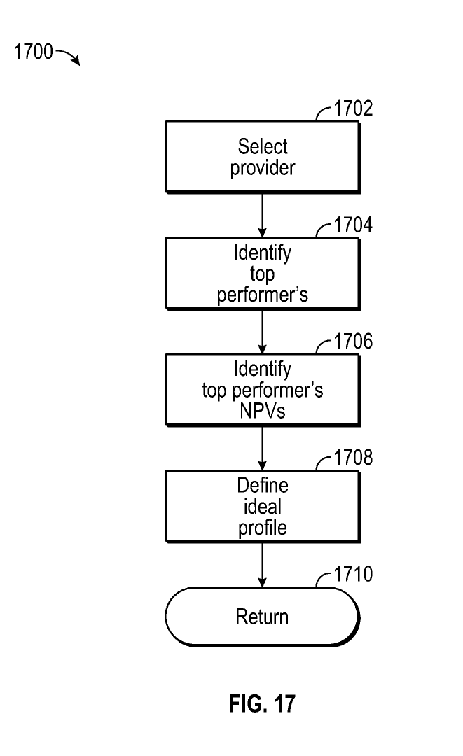

FIG. 17 is a flow diagram illustrating an exemplary process 1700 by which ideal profiles may be created for a plurality of program providers. In particular, the process 1700 involves selecting (Task 1702) a provider from a network of providers, and identifying (Task 1704) top performers who successfully completed that provider's program, based on engagement and outcome data. The process then identifies (Task 1706) common characteristics (e.g., NPVs) for the top performers. The provider's ideal profile may then be defined (Task 1708) in terms of NPVs or other characteristics common to the provider's top performers. The process 1700 then returns (Task 1710) and repeats the process to identify ideal profiles for additional providers.

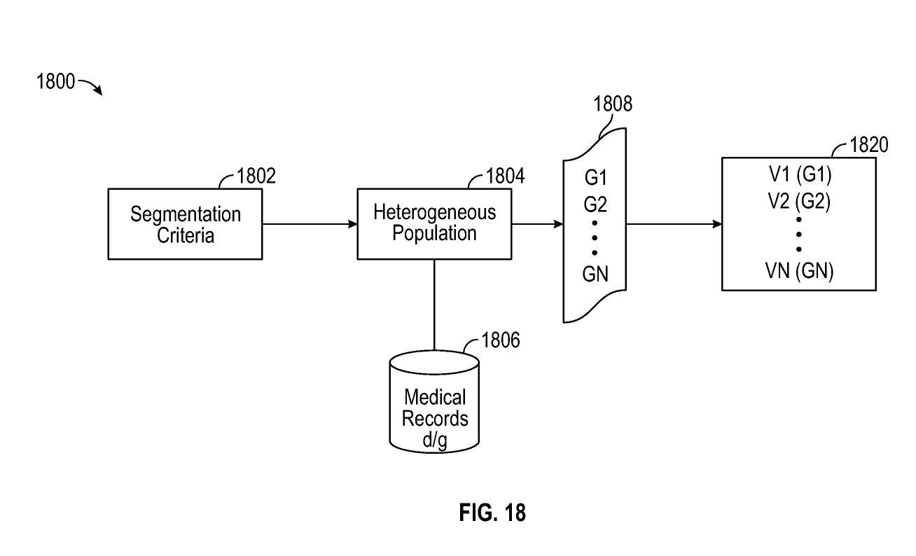

Returning now to the subject of segmentation, FIG. 18 is a schematic block diagram 1800 which illustrates a heterogeneous population broken down into smaller homogeneous sub-groups. More particularly, segmentation criteria 1802 may be used to filter data pertaining to heterogeneous population 1804, for example, population data residing in a medical or patient records database 1806 maintained by an integrator, health plan, or health care provider. Analytic techniques may be employed to break the population 1804 down into smaller, homogeneous groups 1808 (G1-GN), with each group G composed of individuals with similar needs, preferences, attitudes and behaviors. The groups 1808 may be analyzed with variables from a broader behavioral database to which they are members (e.g. medical claims data) to isolate a set of segment-specific variables 1820 for each sub-group. That is, a first unique set of segment-specific variables V1(G1) may be determined for a first homogeneous sub-group G1, a second unique set of segment-specific variables V2(G2) may be determined for a second homogeneous sub-group G1, and so on.

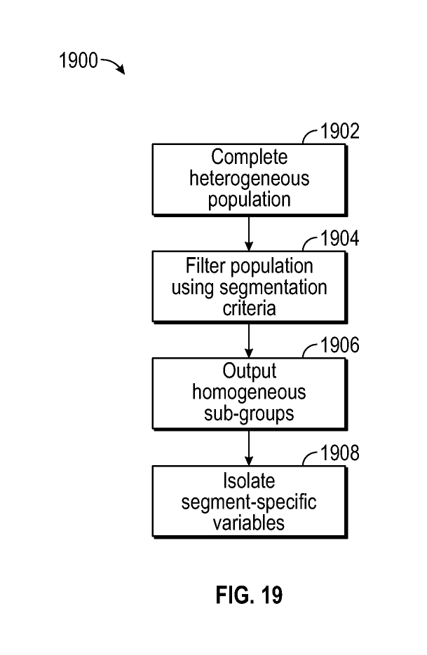

FIG. 19 is a flow diagram illustrating an exemplary process 1900 by which a heterogeneous population may be segmented into smaller homogeneous sub-groups characterized by segment-specific variables. In particular, the process 1900 involves compiling (Task 1902) a database of heterogeneous population data, and using analytic techniques (Task 1904) to break down the heterogeneous population into smaller homogeneous sub-groups based on segmentation criteria, as discussed above. The process 1900 outputs (Task 1906) homogeneous sub-groups G1-GN of individuals, where the individuals within each sub-group share similar needs, attitude, preferences, and/or behaviors. Segment-specific variable may then be isolated (Task 1908) for each homogeneous sub-group.

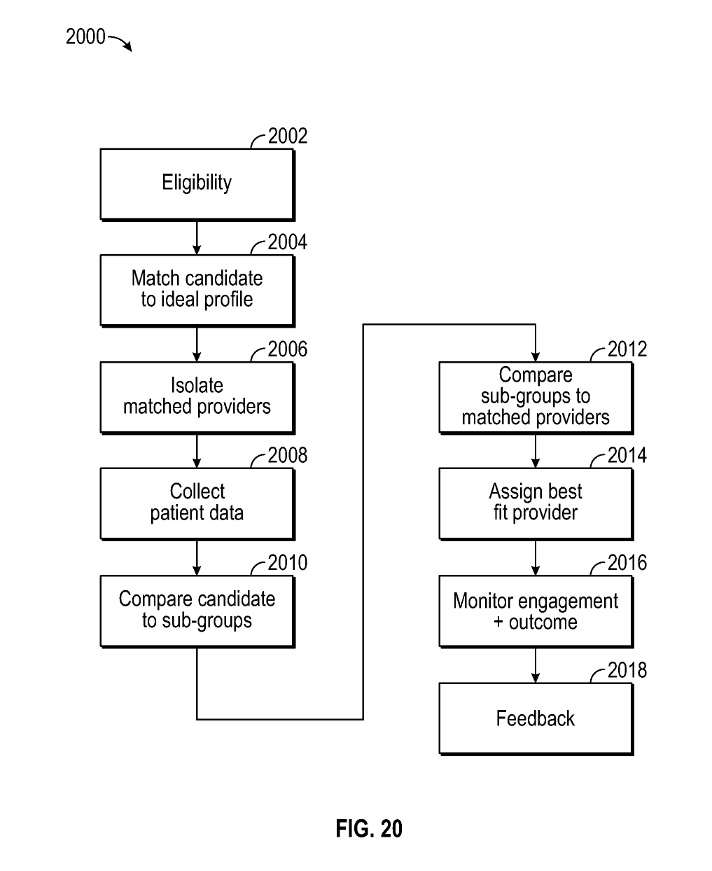

FIG. 20 is a flow diagram illustrating an exemplary process 2000 by which a best fit provider may be selected for a candidate. More particularly, the process 2000 involves determining (Task 2002) whether a candidate is eligible for a program such as DPP. The system may be configured to ask the candidate questions, for example via branched logic, for use in comparing (Task 2004) the candidate with the ideal profiles discussed above in connection with FIGS. 16 and 17. In an embodiment, the system may solicit NPV information for the candidate. In this way, the candidate NPVs may be compared to ideal profile NPVs to isolate (Task 2006) a set of matched ideal profiles for the candidate.

With continued reference to FIG. 20, the process 2000 further involves collecting (Task 2008) Patient Data from the candidate, and comparing (Task 2010) it to segment-specific variables from the homogeneous sub-groups discussed above in connection with FIGS. 18 and 19. Based on this comparison, the candidate may be assigned to one or more of the matching homogeneous sub-groups. The one or more matching sub-groups may then be compared (Task 2012) to the matched ideal profiles identified in Task 2006.

More particularly, the system includes the profiles of the subgroup(s) assigned the ideal participant; the system eliminates unsuitable program providers based on a series of questions administered to the participant relating to, inter alia, co-morbid conditions, BMI and dieting history, education, income, single-parent household, access to transportation, age, gender, race, ethnicity, language, the number and severity of chronic health conditions, the number of prescription medications and medication compliance, health behaviors including frequency of utilization of healthcare and preventive services, and other segmentation criteria.

Based on this comparison (Task 2012), the process 2000 assigns (Task 2014) the candidate to one or more best fit providers. The process 2000 employs machine learning to monitor (Task 2016) engagement and outcomes, and uses this information as feedback (Task 2018) to tune or refine any of the processes or parameters discussed herein such as, for example, creating subsequent ideal profiles.

A method performed by a computer system is thus provided for matching a candidate for a chronic disease prevention program with a provider of the program. The method includes: determining a respective ideal profile for each of a plurality of program providers; segmenting a heterogeneous patient population into a plurality of homogeneous sub-groups; collecting patient data for the candidate; assigning the candidate to a first one of the homogeneous sub-groups based on the patient data; comparing the first sub-group to a plurality of the respective ideal profiles; and selecting a best fit program provider for the candidate based on comparing the first sub-group to a plurality of the respective ideal profiles.

In an embodiment, the chronic disease prevention program comprises a diabetes prevention program.

In an embodiment, determining an ideal profile for a program provider may include: identifying top performers who successfully completed a program delivered by the provider; identifying common characteristics of the top performers; and defining the ideal profile in terms of the common characteristics.

In an embodiment, the common characteristics may include needs and preference variables (NPVs).

In an embodiment, the NPVs may include at least two of: type of curriculum, onsite delivery, individual delivery, group delivery, virtual delivery, telephonic delivery, flexible class schedule, and structured class schedule.

In an alternate embodiment, the NPVs may include at least two of: online, mobile, text, telephonic, video-chat, in-person intervention, one-on-one individual interventions, group-based program delivery; group participation optional, content delivery self-paced, synchronous group participation program led by a coach, daily meal logging, taking pictures of food, volumetrics, point systems, meeting frequency, patient incentives, and monitoring of weight, physical activity, medication and testing.

In an embodiment, segmenting may include filtering the heterogeneous population based on segmentation criteria.

In an embodiment, the segmentation criteria may include demographic and psychographic criteria.

In an alternate embodiment, the segmentation criteria may include information pertaining to at least two of the categories: socioeconomic, health behaviors, readiness to change, level of physical activity, diet, co-morbid health conditions, prescription use, and medical claims data.

In an embodiment, segmenting further includes isolating a unique set of segment-specific variables associated with each homogeneous sub-group, respectively.

In an embodiment, the segment-specific variables may include segmentation criteria.

In an embodiment, the patient data may include patient contact information including the patient's zip code.

In an embodiment, the patient data may include prescription use and compliance information.

In an embodiment, the patient data may include demographics, psychographics, health information, health care utilization, claims data, electronic medical record data, and prescription history data.

In an embodiment, selecting a best fit program provider may include selecting at least two best fit program providers, and using branched logic to allow the candidate to select a preferred one of the at least two best fit program providers.

In an embodiment, the method also includes: enrolling the candidate in a preferred program offered by the best fit program provider; monitoring the candidate's engagement and compliance with the preferred program; and using information obtained from monitoring the candidate's engagement and compliance as feedback in determining subsequent ideal profiles.

Computer code stored in a non-transient medium is also provided for performing, when executed by a computer processor, the steps of: determining an ideal profile for a chronic disease prevention program provider; segmenting a heterogeneous patient population into a homogeneous sub-group; interactively collecting patient data for a candidate; assigning the candidate to the sub-group based on the patient data; determining a correlation between the sub-group and the ideal profile; and assigning the candidate to the program provider based on the correlation.

In an embodiment, segmenting may include filtering the heterogeneous patient population based on predetermined segmentation criteria including demographic and psychographic criteria.

A method is also provided for pairing a candidate for a chronic disease prevention program with a program provider. The method includes: segmenting a heterogeneous patient population into a plurality of homogeneous sub-groups; collecting patient data for the candidate; assigning the candidate to a first one of the homogeneous sub-groups based on the patient data; comparing the first sub-group to a plurality of respective ideal profiles associated with a plurality of program providers; and selecting a best fit program provider for the candidate based on the comparison.

In an embodiment, segmenting comprises applying segmentation criteria to the heterogeneous patient population, the segmentation criteria including demographic and psychographic metrics.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A method performed by a computer system for matching a candidate for a chronic disease prevention program with a program provider, the method comprising:
determining a respective ideal profile for each of a plurality of program providers;
segmenting a heterogeneous patient population into a plurality of homogeneous sub-groups;
collecting patient data for the candidate;
assigning the candidate to a first one of the homogeneous sub-groups based on the patient data;
comparing the first sub-group to a plurality of the respective ideal profiles; and
selecting a best fit program provider for the candidate based on comparing the first sub-group to a plurality of the respective ideal profiles;
enrolling the candidate in a preferred program offered by the best fit program provider;
monitoring the candidate's engagement and compliance with the preferred program; and
using information obtained from the monitoring the candidate's engagement and compliance as feedback in determining subsequent ideal profiles.

2. The method of claim 1, wherein the determining an ideal profile for a program provider further comprises:
identifying top performers who successfully completed a program delivered by the provider;
identifying common characteristics of the top performers; and
defining the ideal profile in terms of the common characteristics.

3. The method of claim 2, wherein the common characteristics comprise at least two of: type of curriculum, onsite delivery; individual delivery, group delivery, virtual delivery, telephonic delivery, flexible class schedule, and structured class schedule.

4. The method of claim 2, wherein the common characteristics comprise at least two of: online, mobile, text, telephonic, video-chat, in-person intervention, one-on-one individual interventions, group-based program delivery, group participation optional, content delivery self-paced, synchronous group participation program led by a coach, daily meal logging, taking pictures of food, volumetrics, point systems, meeting frequency, and monitoring of weight, physical activity, medication and testing.

5. The method of claim 1, wherein the segmenting the heterogeneous patient population further comprises filtering the heterogeneous population based on segmentation criteria.

6. The method of claim 5, wherein the segmentation criteria comprises demographic and psychographic criteria.

7. The method of claim 5, wherein the segmentation criteria comprises information pertaining to at least two of the categories: socioeconomic, health behaviors, readiness to change, level of physical activity, diet, co-morbid health conditions, prescription use, and medical claims data.

8. The method of claim 1, wherein the segmenting the heterogeneous patient population further comprises isolating a unique set of segment-specific variables associated with each homogeneous sub-group, respectively.

9. The method of claim 8, wherein the segment-specific variables comprise segmentation criteria.

10. The method of claim 1, wherein the patient data comprises patient contact information including zip code.

11. The method of claim 1, wherein the patient data comprises prescription use and compliance information.

12. The method of claim 1, wherein the patient data comprises demographics, psychographics, health information, health care utilization, claims data, electronic medical record data, and prescription history data.

13. The method of claim 1, wherein the selecting a best fit program provider further comprises selecting at least two best fit program providers, and using branched logic to allow the candidate to select a preferred one of the at least two best fit program providers.

14. A method performed by a computer system for matching a candidate for a chronic disease prevention program with a program provider, the method comprising:
determining a respective ideal profile for each of a plurality of program providers;
filtering a heterogeneous patient population based on segmentation criteria comprising demographic and psychographic criteria
segmenting the filtered heterogeneous patient population into a plurality of homogeneous sub-groups;
collecting patient data for the candidate;
assigning the candidate to a first one of the homogeneous sub-groups based on the patient data;
comparing the first sub-group to a plurality of the respective ideal profiles; and
selecting a best fit program provider for the candidate based on comparing the first sub-group to a plurality of the respective ideal profiles.

15. The method of claim 14, wherein determining an ideal profile for a program provider comprises:
identifying top performers who successfully completed a program delivered by the provider;
identifying common characteristics of the top performers; and
defining the ideal profile in terms of the common characteristics.

16. The method of claim 15, wherein the common characteristics comprise at least two of: type of curriculum, onsite delivery, individual delivery, group delivery, virtual delivery, telephonic delivery, flexible class schedule, and structured class schedule.

17. The method of claim 15, wherein the common characteristics comprise at least two of: online, mobile, text, telephonic, video-chat, in-person intervention, one-on-one individual interventions, group-based program delivery, group participation optional. content delivery self-paced, synchronous group participation program led by a coach, daily meal logging, taking pictures of food, volumetrics, point systems, meeting frequency, and monitoring of weight, physical activity, medication, and testing.

18. The method of claim 14, wherein the filtering the heterogeneous patient population further comprises filtering the heterogeneous population based on segmentation criteria comprising information pertaining to at least two of the categories: socioeconomic, health behaviors, readiness to change, level of physical activity, diet, co-morbid health conditions, prescription use, and medical claims data.

19. The method of claim 14, wherein the filtering the heterogeneous patient population further comprises isolating a unique set of segment-specific variables associated with each homogeneous sub-group, respectively.

20. The method of claim 19, wherein the segment-specific variables comprise segmentation criteria.

21. The method of claim 14, wherein the patient data comprises patient contact information including zip code.

22. The method of claim 14, wherein the patient data comprises prescription use and compliance information.

23. The method of claim 14, wherein the patient data comprises demographics, psychographics, health information, health care utilization, claims data, electronic medical record data, and prescription history data.

24. The method of claim 14, wherein the selecting a best fit program provider further comprises selecting at least two best fit program providers, and using branched logic to allow the candidate to select a preferred one of the at least two best fit program providers.

25. The method of claim 14, further comprising:
enrolling the candidate in a preferred program offered by the best fit program provider;
monitoring the candidate's engagement and compliance with the preferred program; and
using information obtained from the monitoring the candidate's engagement and compliance as feedback in determining subsequent ideal profiles.

26. Computer code stored in a non-transient medium for performing, when executed by a computer processor, the steps of:
determining an ideal profile for a chronic disease prevention program provider;
filtering a heterogeneous patient population based on predetermined segmentation criteria comprising demographic and psychographic criteria
segmenting the filtered heterogeneous patient population into a homogeneous sub-group;
interactively collecting patient data for a candidate;
assigning the candidate to the sub-group based on the patient data;
determining a correlation between the sub-group and the ideal profile; and
assigning the candidate to the program provider based on the correlation.

27. The computer code of claim 26, further comprising the steps of:
enrolling the candidate in a preferred program offered by the best fit program provider;
monitoring the candidate's engagement and compliance with the preferred program; and
using information obtained from the monitoring the candidate's engagement and compliance as feedback in determining subsequent ideal profiles.

28. A method of pairing a candidate for a chronic disease prevention program with a program provider, the method comprising:
segmenting a heterogeneous patient population into a plurality of homogeneous sub-groups;
collecting patient data for the candidate;
assigning the candidate to a first one of the homogeneous sub-groups based on the patient data;
comparing the first sub-group to a plurality of respective ideal profiles associated with a plurality of program providers;
selecting a best fit program provider for the candidate based on the comparison;
enrolling the candidate in a preferred program offered by the best fit program provider;
monitoring the candidate's engagement and compliance with the preferred program; and
using information obtained from the monitoring the candidate's engagement and compliance as feedback in determining subsequent ideal profiles.

29. The method of claim 28, further comprising:
identifying top performers who successfully completed a program delivered by a program provider;
identifying common characteristics of the top performers;
defining an ideal profile in terms of the common characteristics; and
determining a respective ideal profile for each of a plurality of program providers.

30. The method of claim 28, further comprising:
assigning the candidate to the sub-group based on the patient data;
determining a correlation between the sub-group and the ideal profile; and
assigning the candidate to the program provider based on the correlation.
